(19) United States
(12) Patent Application Publication
(10) Pub. No.: US 2017/0085090 A1
(43) Pub. Date: Mar. 23, 2017

(54) FOUR-QUADRANT PARTIAL POWER PROCESSING SWITCHED-MODE CONVERTER FOR PHOTOVOLTAIC APPLICATIONS

(71) Applicant: Solar Ship Inc., Toronto (CA)

(72) Inventors: Ahmad Diab Marzouk, Mississauga (CA); Olivier Trescases, Toronto (CA)

(21) Appl. No.: 15/311,672

(22) PCT Filed: May 19, 2015
(86) PCT No.: PCT/CA2015/050446

§ 371 Date: Nov. 16, 2016

Related U.S. Application Data
(60) Provisional application No. 61/994,322, filed on May 16, 2014.

(51) Int. Cl. H02J 3/38; H02M 3/335

(52) U.S. Cl. CPC H02J 3/383; H02M 3/33507

(57) ABSTRACT

Habitations in remote areas around the world lack basic infrastructure to achieve an efficient supply chain. Over 90% of roads are unpaved and fuel infrastructure is scarce. A solar-powered hybrid airship was conceived to address this problem. It is a buoyant low-altitude aircraft with an electric power train and wing-mounted photovoltaic array. Fully electric operation requires efficient lightweight power electronics to maximize range and payload. A Partial Power Processing (PPP) converter based on the bidirectional Cuk topology is demonstrated for this application. Due to the PPP concept, the converter is rated for only about a quarter of the generated PV power. The rating is optimized based on the battery and photovoltaic array voltage ranges. The experimental prototype uses Silicon Carbide MOSFETS and achieves a system efficiency of up to 99.3%.

### TECHNICAL FIELD

The present invention relates to photovoltaic (PV) power generation and, more particularly, to a partial power processing converter for PV applications.

### BACKGROUND

A Partial Power Processing (PPP) converter only processes a portion of the full power supplied by the input bus. Processing only a portion of the power allows to reduce the size of heat sinks and magnetic components, where applicable in the topology. A partial power converter may be implemented to operate in buck mode, boost mode, or both depending on the application at hand. The scheme in this disclosure is a buck-boost partial power processing converter for use with a PV input bus, and output battery bus. The converter's function is to track the maximum power point of the input PV panel under different environmental conditions, and deliver this power to the battery bus.

The following references are relevant to this technology and are referenced throughout the present disclosure:

[1] M. Joshi, E. Shoubaki, R. Amarin, B. Modick, and J. Enslin, “A high-efficiency resonant solar micro-inverter,” in Power Electronics and Applications (EPE 2011), Proceedings of the 2011-14th European Conference on, August 2011, pp. 1-10.

[2] R. Erickson and D. Maksimovic, Fundamentals of Power Electronics, ser. Power electronics. Springer, 2001.

[3] A. G. Birchenough, “A High Efficiency DC Bus Regulator/RPC for Spacecraft Applications,” in Space Technology and Applications, ser. American Institute of Physics Conference Series, M. S. El-Genk, Ed., vol. 699, February 2004, pp. 606-613.

[4] U.S. Pat. No. 7,042,199 (Birchenough) entitled “Series connected buck-boost regulator” issued May 9, 2006.

[5] D. Snyman and J. H. R. Enslin, “Novel technique for improved power conversion efficiency in pv systems with battery back-up,” in Telecommunications Energy Conference, 1991. INTELEC '91., 13th International, 1991, pp. 86-91.

[6] M. Agamy, M. Harfman-Todorovic, A. Elasser, S. Chi, R. Steigerwald, J. Sabate, A. McCann, L. Zhang, and F. Mueller, “An efficient partial power processing dc/dc converter for distributed pv architectures,” Power Electronics, IEEE Transactions on, vol. 29, no. 2, pp. 674-686, February 2014.

[7] R. Button, “An advanced photovoltaic array regulator module,” in Energy Conversion Engineering Conference, 1996. IECEC 96., Proceedings of the 31st Intersociety, vol. 1, 1996, pp. 519-524 vol.l.

Partial power processing has been proposed in the following references:
1. Reference [3] discusses a partial power processing buck-boost converter with a prototype. The work in [3] has been patented in Reference [4], viz. U.S. Pat. No. 7,042,199.
2. References [5] and [6] use a capacitor connected between the input bus and output bus to achieve partial power processing. The topology in [5] is non-isolated and only capable of buck mode. The topology in [6] is non-isolated and only capable of boost mode. These references will not be discussed in this disclosure.
3. Reference [7] discusses the concept of a series connected boost unit (SCBU). This is a partial power converter that only contains boost mode. No schematic or circuit topology has been proposed and no patent has been found by applicant. This work will not be discussed in this disclosure.

The series connected buck-boost in U.S. Pat. No. 7,042,199 (Reference [4]) provides a buck-boost capability, isolated topology, and partial power operation. The prior-art topology is reproduced as FIG. 12.

U.S. Pat. 7,042,199 relies on a full bridge converter scheme for boost mode, and a similar scheme for buck mode. The scheme utilizes eight switches for its full operation. The enabled switches depend on the chosen operating mode (buck or boost mode). The partial power processing is achieved by having the input bus permanently connected to the center tap of the transformer.

Improvements on this technology remain highly desirable. In particular, it would be desirable to make the converter more efficient (by minimizing losses), more reliable and lighter.

### SUMMARY

In general, the present invention is embodied as a partial power processing (PPP) converter circuit having an isolated bi-directional dc-dc converter for connection to both a PV string and a battery. The converter may have a Cuk topology. The circuit includes an unfolder bridge for switching between buck and boost modes.

Accordingly, an inventive aspect of the present disclosure is a partial power processing (PPP) converter circuit comprising a photovoltaic array string that generates a voltage V_{PV} and current I_{PV}, a battery that supplies a voltage V_{BATT} and current I_{BATT}, a PPP converter connected in a circuit between the photovoltaic array string and the battery, the converter alternately operable in buck mode and boost mode, wherein the converter is an isolated bi-directional dc-dc converter. The converter, in one embodiment, has a Ćuk topology. In one embodiment, the Ćuk topology has only two high frequency switches. In one embodiment, PPP converter circuit includes an unfolder bridge for switching between buck and boost modes. The unfolder bridge may be turned off simultaneously with active switches Q₁ and Q₂ to swich between buck and boost modes. The active switches Q₁ and Q₂ may remain active in both buck and boost modes. In one embodiment, the unfolder includes a bridge of four bidirectional blocking switches.

Another inventive aspect of the present disclosure is an unfolder circuit for switching a partial power processing (PPP) converter between buck and boost modes, the unfolder circuit comprising a bridge of four bidirectional blocking switches.

The summary is intended to present only the most significant inventive aspects that are now apparent to the inventor and is not intended to be an exhaustive or limiting recitation of all inventive aspects. Other inventive aspects of the disclosure may become apparent to those of ordinary skill in the art.

### BRIEF DESCRIPTION OF DRAWINGS

FIG. 1 depicts a partial power processing dc-dc converter connected between a PV string and a battery.

FIG. 2A depicts the relative magnitudes of V_{BATT} and V_{PV} in buck-boost mode.

FIG. 2B depicts the relative magnitudes of V_{BATT} and V_{PV} in buck mode only.

FIG. 2C depicts the relative magnitudes of V_{BATT} and V_{PV} in boost mode only.

FIG. 3 depicts a buck mode in the PPP converter in which V_{BATT}>V_{PV}.

FIG. 4 depicts a boost mode in the PPP converter in which V_{BATT}<V_{PV}.

FIG. 5A depicts a system efficiency using a PPP scheme in buck mode.

FIG. 5B depicts a system efficiency using a PPP scheme in boost mode.

FIG. 6 depicts an isolated bidirectional Ćuk converter.

FIG. 7A depicts a high-level control diagram with inner loop.

FIG. 7B depicts V_{PV} tracking V_{PV,ref} during the MPPT process.

FIG. 8 depicts an experimental MPPT startup waveform on a commercial solar installation for P_{PV}=1.65 kW.

FIG. 9 depicts an unfolder concept to achieve bipolar output.

FIG. 10 depicts an unfolder implementation.

FIG. 11 depicts a complete PPP converter topology.

FIG. 12 depicts a prior-art PPP converter topology.

FIG. 13 depicts an overview of the Solarship electrical architecture.

### DETAILED DESCRIPTION

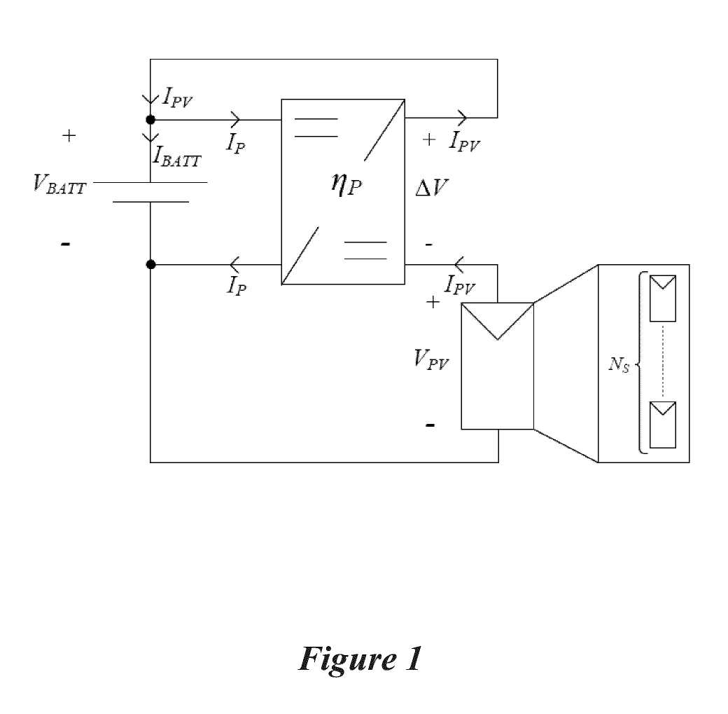

The PPP concept is outlined in FIG. 1 for a single photovoltaic (PV) string, where V_{PV} and I_{PV} are the PV string voltage and current, respectively, V_{BATT} is the battery bus voltage, rᵢₚ is the converter efficiency, I_{P} is the current at the battery port, and ΔV is the voltage at the secondary port of the PPP converter. The processed power of the dc-dc converter, P_{P}, is proportional to the difference between the battery and PV voltages,

P_{P}=ΔV·I_{PV}, (1)

which implies that for sufficiently low ΔV, the processed power can be minimized compared to the full PV power.

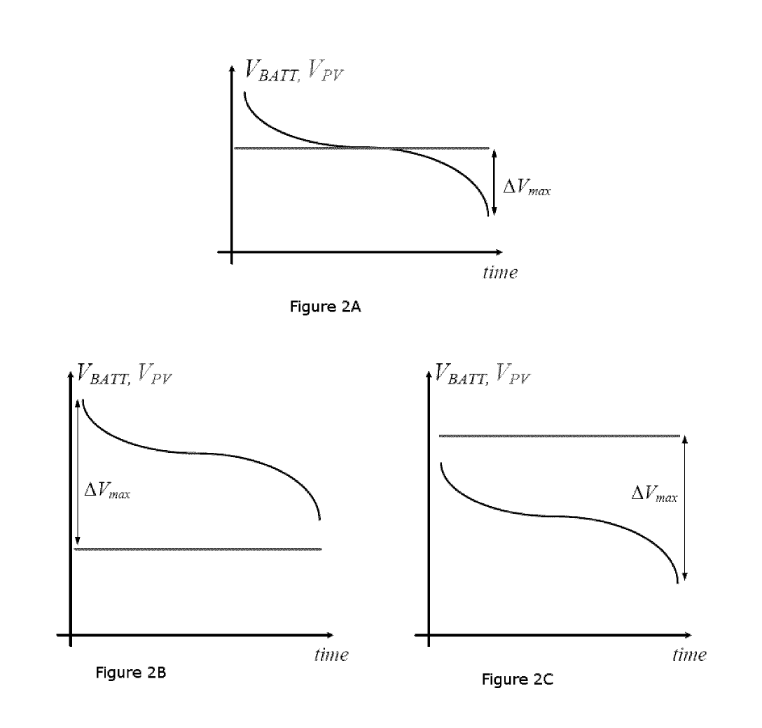

In order to minimize the power rating of the dc-dc converter in FIG. 1, the converter needs to operate both in buck and boost modes. Operating in this fashion allows reduction of the voltage difference ΔV, thus minimizing the processed power as a result. This reduction is achieved when the voltage of the PV string is optimized with respect to the battery bus voltage to minimize this difference as shown in FIGS. 2A, 2B and 2C.

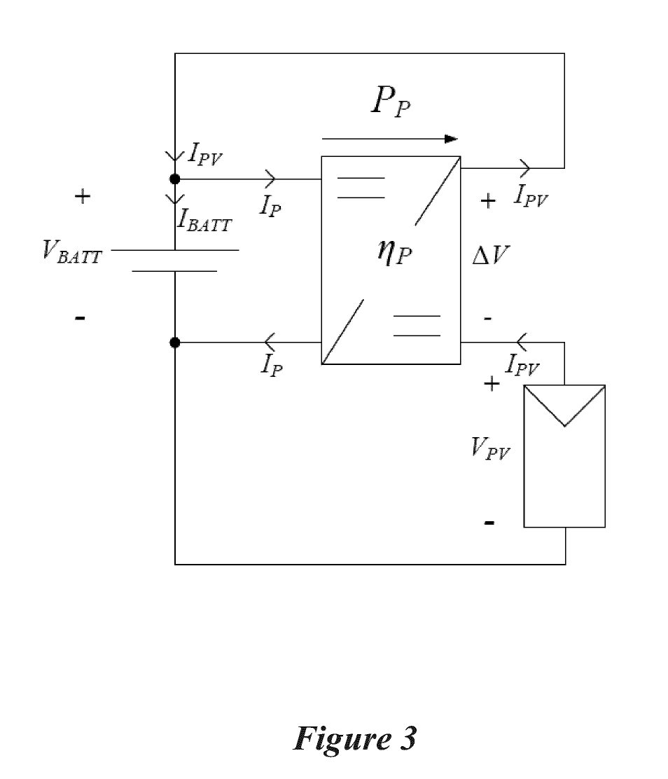

Buck mode operation is shown in FIG. 3. The arrow above the converter indicates the direction of power transfer. In this mode, V_{PV} is given by,

V_{PV}=V_{BATT}−ΔV, (2)

where V_{PV} is less than V_{BATT}.

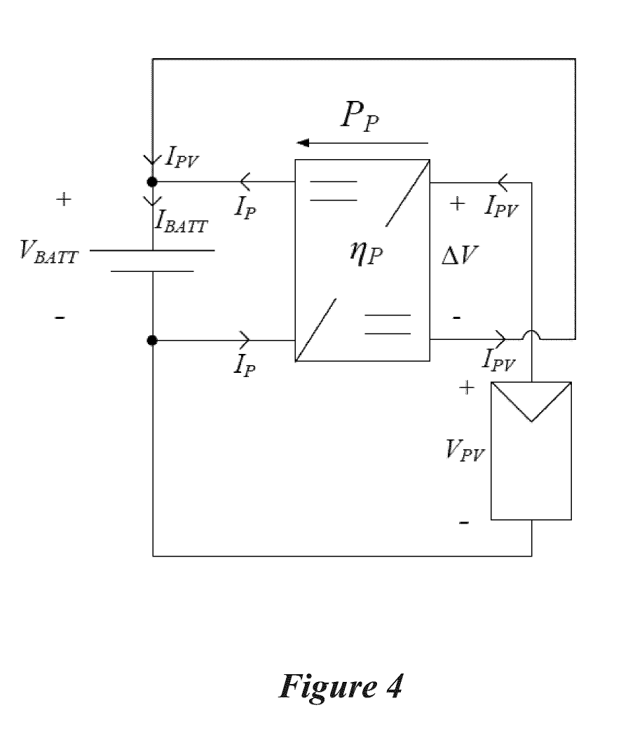

Boost mode operation is shown in FIG. 4. In this case,

V_{PV}=V_{BATT}+ΔV, (3)

where V_{PV} is greater than V_{BATT}. In boost mode, the direction of power transfer in the dc-dc converter is reversed.

Note that in both modes, power is transferred from the PV array to the battery, since I_{P} is less than I_{PV}, hence I_{BATT} is positive. The system efficiency, η_{sys}, can be expressed as a function of PPP converter efficiency, η_{P}, in both modes. For buck mode,

$$\begin{matrix}{η}_{sys} = \frac{{P}_{BATT}}{{P}_{PV}} \\ = \frac{{V}_{BATT} ( {I}_{PV} - {I}_{P} )}{{V}_{PV} {I}_{V}} \\ = \frac{1 - \frac{Δ V}{{η}_{P} {V}_{BATT}}}{1 - \frac{Δ V}{{V}_{BATT}}} .\end{matrix} \qquad ( 4 )$$

For boost mode,

$$\begin{matrix}{η}_{sys} = \frac{{P}_{BATT}}{{P}_{PV}} \\ = \frac{{V}_{BATT} ( {I}_{PV} + {I}_{P} )}{{V}_{PV} {I}_{V}} \\ = \frac{1 + \frac{Δ V}{{η}_{P} {V}_{BATT}}}{1 + \frac{Δ V}{{V}_{BATT}}} .\end{matrix} \qquad ( 5 )$$

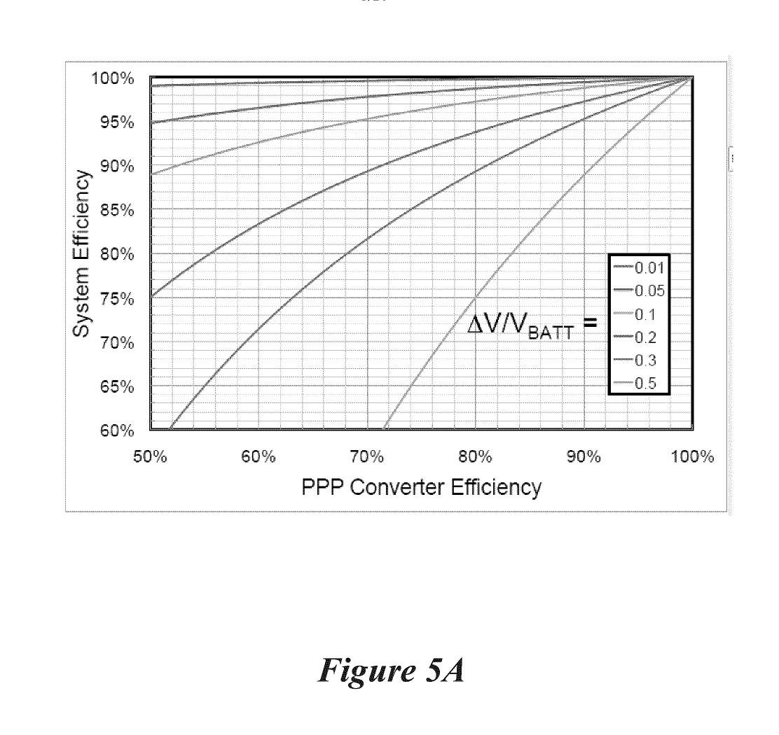

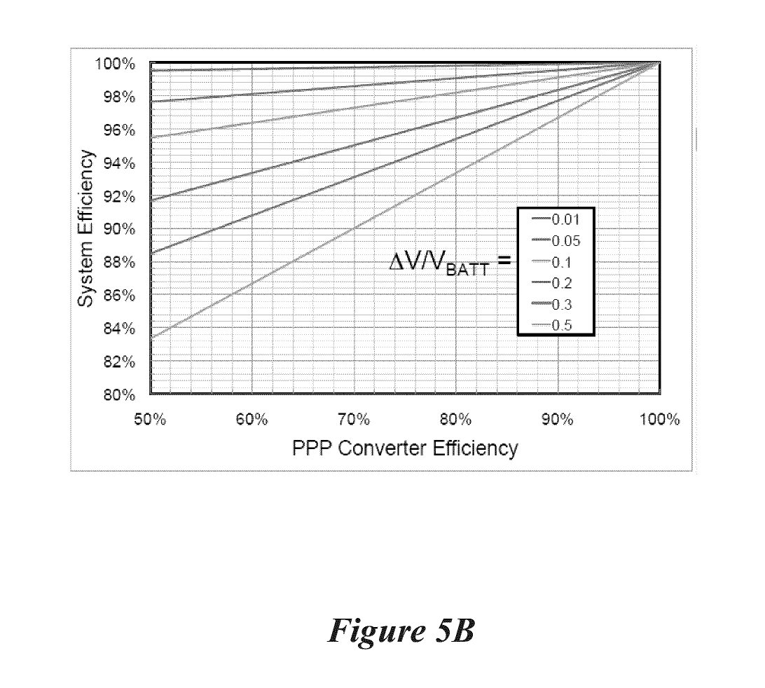

From (4) and (5), it is clear that for a small ratio of ΔV/V_{BATT}, when the PV and battery voltages are nearly identical, the system efficiency is not sensitive to the converter efficiency, η_{P}, as shown in FIG. 5.

This operation is realized by a four-quadrant isolated converter. Four-quadrant operation is necessary since current must flow in both directions, and the converter must be capable of bipolar voltage output.

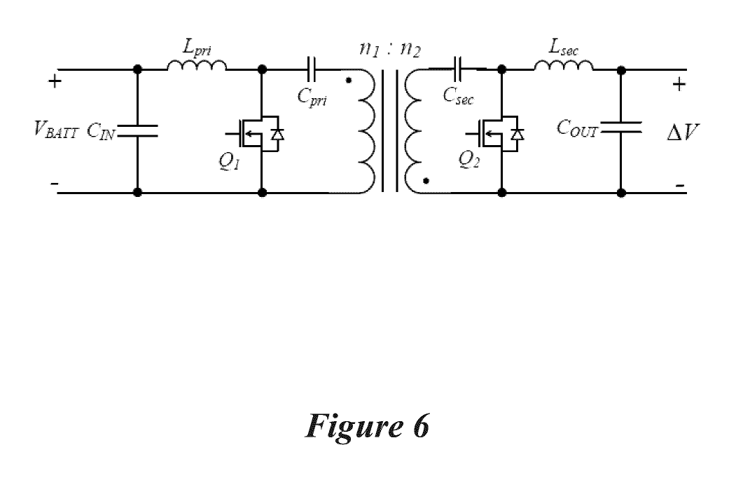

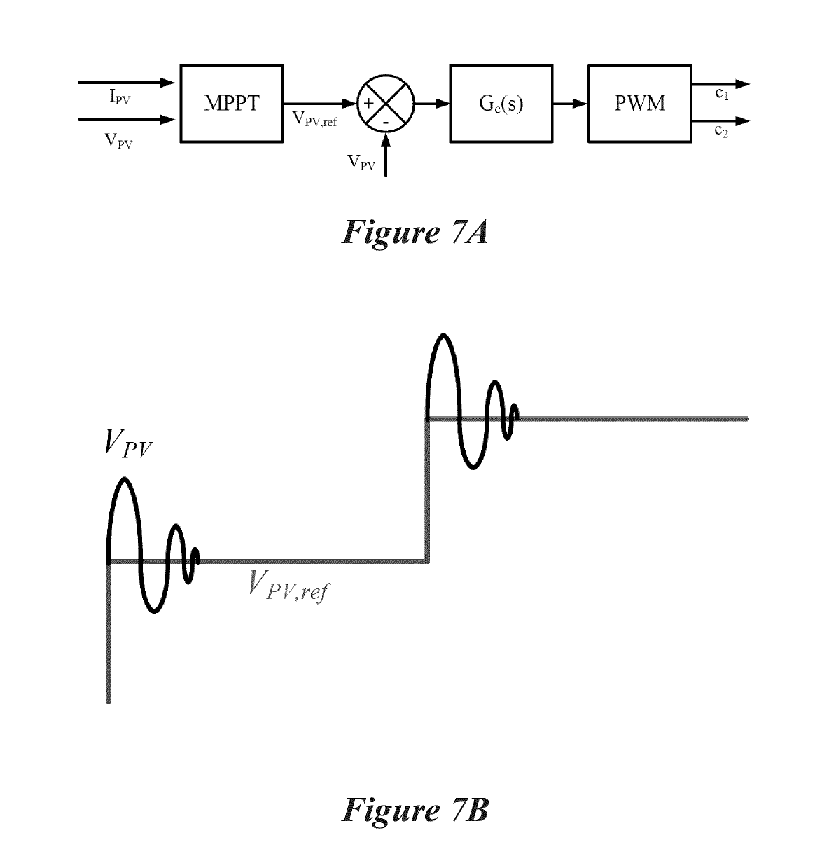

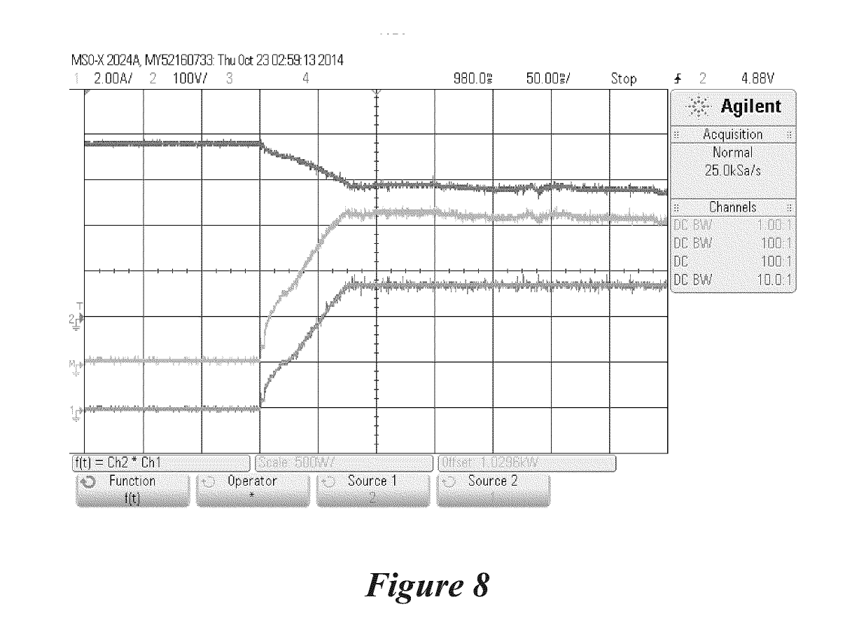

It is possible to realize the above requirements by starting with an isolated bidirectional converter, modified to achieve bipolar operation. The isolated Ćuk converter shown in FIG. 6 is capable of bidirectional power transfer, contains only two low-side switches, and operates at fixed frequency. At the same time it has three magnetic components and may require external snubbers. The Ćuk converter is chosen in this work due to its reduced number of high-frequency switches. The magnetic component size is reduced by operating at a high switching frequency, which may be facilitated by using wide-bandgap semiconductor switches, such as Silicon-Carbide (SiC) or Gallium Nitride (GaN). Continuous current in both inductors reduces the size of the input and output capacitors. Duty cycle control is used to achieve MPPT at high bandwidth as shown in FIGS. 7A and 7B, where V_{PV} tracks the reference V_{PV,ref} to quickly reach maximum power using an inner-loop and a controller G_{c}(s). An experimental verification, using a PPP prototype, is shown in FIG. 8, where MPPT convergence is reached within 70 ms on a commercial solar installation at a PV power of P_{PV}=1.65 kW.

The conversion ratio, M=ΔV/V_{BATT}, is ideally independent of the load condition in Continuous Conduction Mode (CCM),

$$M = \frac{{n}_{2}}{{n}_{1}} \frac{D}{1 - D} . \qquad ( 6 )$$

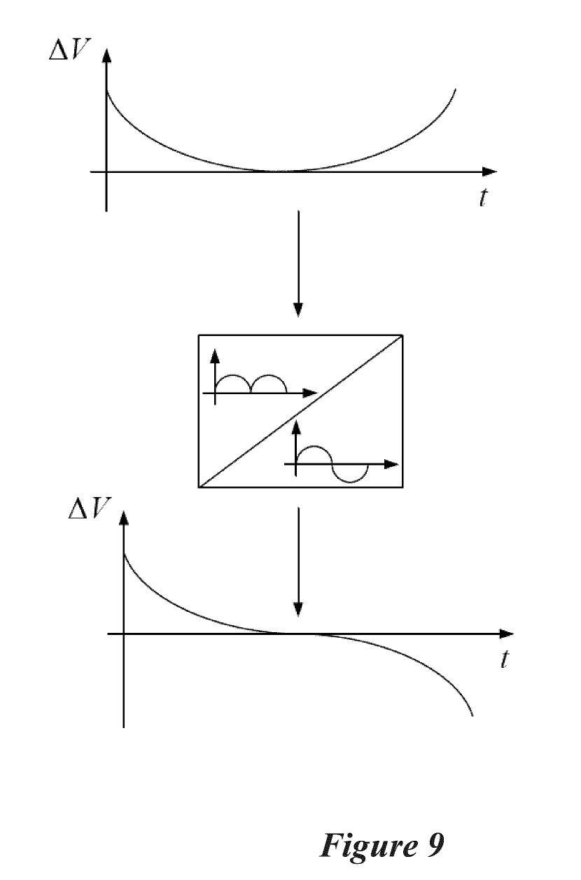

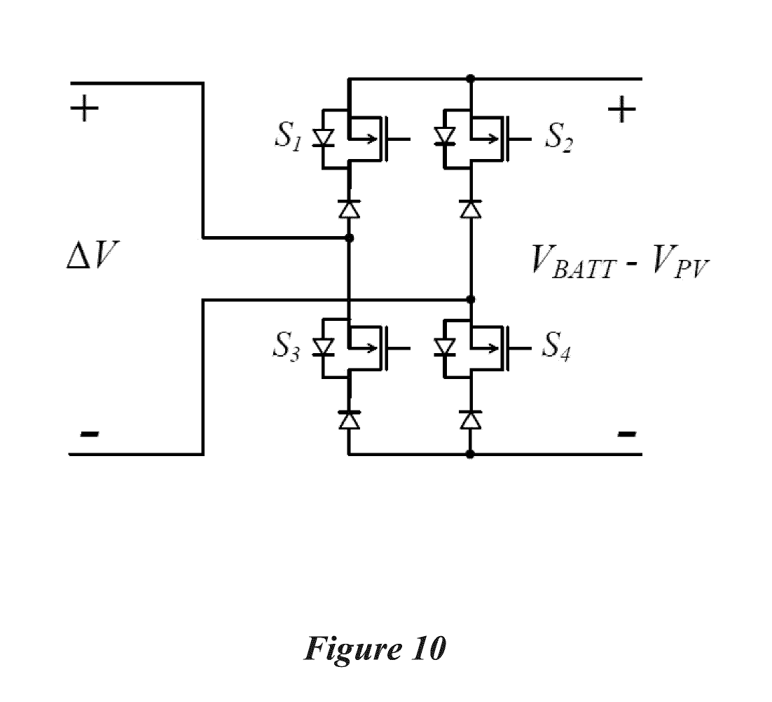

In order to achieve a bipolar output, an additional bridge is used at the secondary side, similar to the unfolder in single-stage PV microinverters [1], as shown in FIG. 9. The unfolder can actively invert ΔV in boost mode. The unfolder is realized by a bridge of four bidirectional blocking switches as shown in FIG. 10.

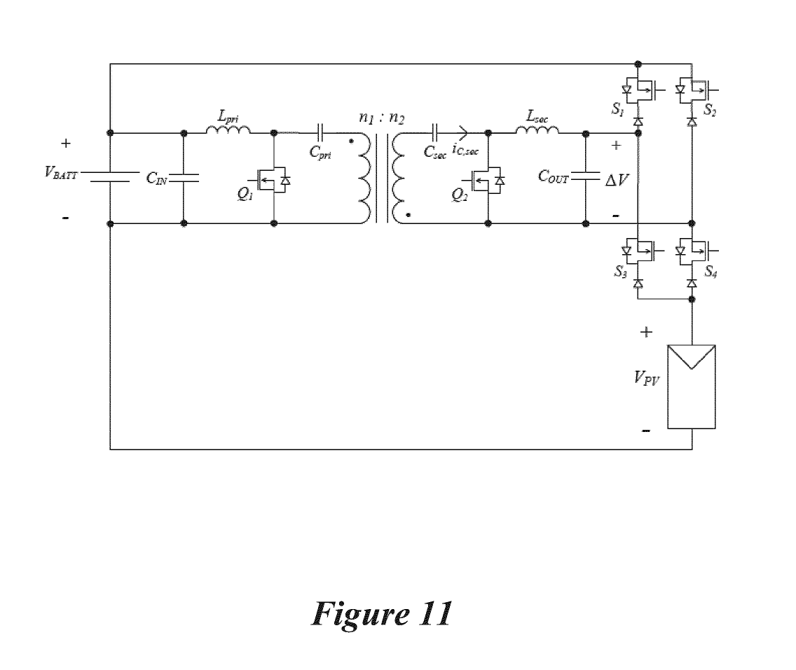

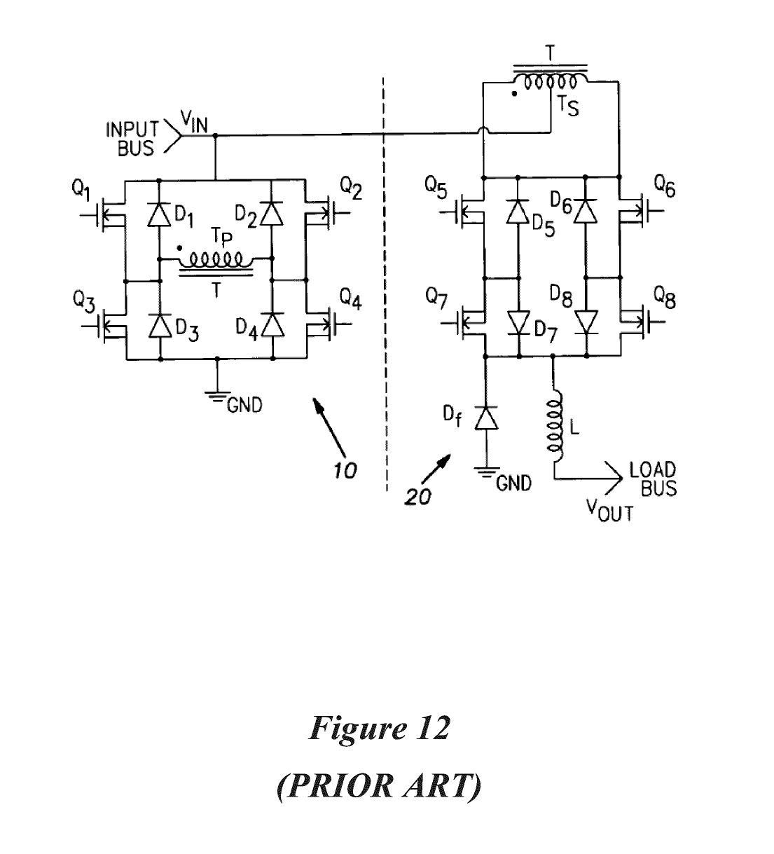

Only two sets of switches are enabled in each mode: (S₁, S₄) in buck mode, (S₂, S₃) in boost mode. Given that ΔV changes sign very slowly based on irradiance and battery voltage fluctuations, the low-frequency unfolder only contributes to conduction losses. It is therefore recommended to use low Rₒₙ and low V_{f} devices. Moreover, the bridge provides an additional safety disconnect feature for the PV array, which is why it is connected on the secondary side. The complete PPP topology is shown in FIG. 11.

The design procedure for the Cuk converter is well covered in the literature [2] and not repeated here. If ΔV is smaller then V_{BATT}, the input current, voltage stress, and inductor voltage swings decrease in the converter. This allows the reduction or elimination of any required snubbers in the converter, use of smaller inductors, and higher FOM switches.

The transition between buck and boost modes is done by controlling the unfolder bridge and active switches simultaneously. In some embodiments, the active switches are turned off simultaneously with the unfolder. The energy stored in the inductor, L_{sec} is transferred to both C_{sec} and C_{OUT}. While this increases the voltage on the capacitors, the energy stored in the inductor is much less than that of the capacitors. The unfolder switches for the other mode are then enabled to complete the transition.

In boost mode, the full bridge converter of U.S. Pat. No. 7,042,199 has six active switches: Q₁ to Q₄ and Q₇, Q₈; Q₅ and Q₆ are permanently on and do not contribute in the operation. For the full bridge to function, switches Q₁ to Q₄ impose a zero DC voltage square waveform on the primary side of the transformer with Q₇ and Q₈ conducting at different intervals. During this operation, there are six high frequency switches that are active. This differs greatly from the operation in the Ćuk topology of the present invention, where only two high frequency switches are active. A greater number of active switches degrades the converter efficiency due to increased switching and/or conduction losses; particularly when the topology is hard switching. In addition, the operation of the Ćuk converter in the present invention does not require four switching states as the full bridge does in U.S. Pat. No. 7,042,199; only two are sufficient due to the presence of the series capacitors on either side of the transformer. This increases the reliability of the converter, where the transformer is passively protected from saturation effects.

In buck mode, the full bridge converter of U.S. Pat. No. 7,042,199 also has six active switches: Q₁ to Q₄ and Q₅, Q₆; Q₇ and Q₈ are permanently on and do not contribute in the operation. For the full bridge to function, switches Q₅ to Q₆ impose a zero DC voltage square waveform on the secondary side of the transformer. The primary side conducts either using synchronous rectification or through the use of MOSFET body diodes.

With the above in mind, there are a number of notable differences between the embodiments of the present invention and the prior art:
1. The partial power concept of the present invention is achieved by feeding forward the input bus to an unfolder as shown in FIG. 9 whereas, in contrast, the prior art connects the input bus directly to the center tap of the transformer.
2. Embodiments of the present invention only use two active high frequency switches for buck and boost modes whereas the prior art uses six high frequency switches for buck and boost modes.
3. Switching between modes in the embodiments of the present invention is done through the unfolder, which effectively connects the input bus to the opposite terminal on the secondary side; this has the effect of reversing the power flow. The active switches, Q₁ and Q₂, remain the active switches in both modes. In the prior art, the switching of modes is achieved by changing the active switches Q₇, Q₈ which actively switch in boost mode, to Q₅ and Q₆, which now actively switch in buck mode. This is necessary since the full-bridge converter is not inherently bidirectional.
4. The embodiments of the present invention utilize a simple two-winding transformer thereby obivating the need for a center-tapped transformer like U.S. Pat. No. 7,042,199.

In addition, the embodiments of the present invention have been demonstrated to work with high efficiency at a switching frequency of 200 kHz using SiC power transistors with clearly stated mass and power density. The prior art has only demonstrated a switching frequency of only 25 kHz [3]; eight times less than the frequency of the embodiments of the present invention. It is expected that the listed efficiency in [3] will degrade at high frequency given the number of active switches in place.

The invention described herein is particularly useful in weight-sensitive aeronautic or aerospace applications although this invention may also be utilized in other applications. In particular, this invention is considered to be especially well-suited for solar-powered aircraft such as the Solarship designed and manufactured by Solar Ship Inc. of Toronto, Ontario, Canada. The Solarship is designed to operate in remote areas that have little or no fuel infrastructure.

The Solarship aims to address the economic and logistical barriers that prevent adequate supply delivery to remote regions around the globe by (1) reducing the cost of transport, (2) enabling movement in-and-out of areas where other transport methods are ineffective due to lack of fuel and runways, and (3) ensuring cold chain storage and distribution. The Solarship is a hybrid between a bush plane and an airship. The added buoyancy from the helium-filled wing increases the payload, while the heavier-than-air design eliminates the need for expensive anchors.

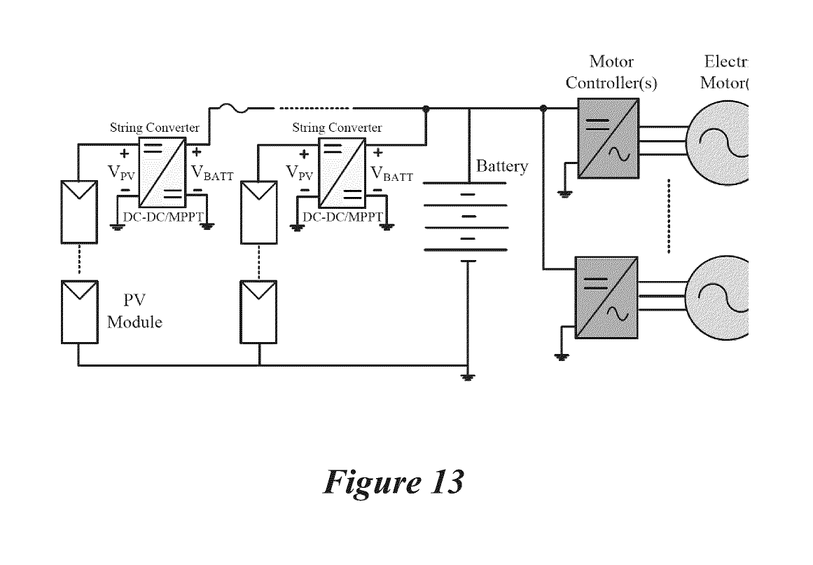

One of the greatest advantages compared to standard aircraft is the ability to land in a small area the size of a soccer field. The simplified Solarship electrical architecture, which is similar to ground based Electric Vehicles (EVs), consists of a central battery pack, electric motors driven by inverters, and a set of dc-dc converters for performing Distributed Maximum Power Point Tracking (DMPPT) on the wing-mounted PV array as shown in FIG. 13. A DMPPT Partial Power Processing (PPP) converter approach based on the invention described herein is a considerable improvement for this weight-sensitive aerospace application because it reduces the power rating of the dc-dc converter, and thus reduces the mass of heat sinks and magnetic components.

Various modifications, refinements, alterations and variations to the embodiments described above may be implemented. For example, some contemplated modifications are as follows:
1. The unfolder implementation may completely consist of active switches. This is opposed to one active switch and one passive switch as implemented in the embodiments described above. Using active bi-directional switches in the unfolder would reduce the conduction losses, which increasing the cost.
2. The concept of using an unfolder connected to an isolated bidirectional topology is unique and first proposed in this disclosure. The concept is particularly useful when the ground terminal of the battery bus and PV array must be connected together for safety reasons. The unfolder concept theoretically works with any isolated bidirectional topology in order to achieve the partial power concept and buck-boost operation.
3. The switch implementation in this disclosure can be MOSFETS or IGBTS or any kind that is capable of performing similar switching action. The concept is particularly useful when the ground terminal of the battery bus and PV array must be connected together for safety reasons.
4. Burst-mode control or any pulse frequency modulation scheme is possible for this converter under light load conditions to improve efficiency.
5. Maximum point power tracking (MPPT) of the PV panel may be achieved using any method suitable with duty cycle or current mode control.
6. It is possible to enable a pass-through mode that directly connects the PV string the battery bus via the unfolder bridge. This pass-through mode would reduce the losses when the battery and PV voltages are nearly identical.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

The embodiments of the invention described above are intended to be exemplary only. As will be appreciated by those of ordinary skill in the art, to whom this specification is addressed, many other variations, modifications, and refinements can be made to the embodiments presented herein without departing from the inventive concept(s) disclosed herein. The scope of the exclusive right sought by the applicant(s) is therefore intended to be limited solely by the appended claims.

1. A partial power processing (PPP) converter circuit comprising:
a photovoltaic array string that generates a voltage V_{PV} and current I_{PV};
a battery that supplies a voltage V_{BATT} and current I_{BATT};
a PPP converter connected in a circuit between the photovoltaic array string and the battery, the converter alternately operable in buck mode and boost mode, wherein the converter is an isolated bi-directional dc-dc converter; and
an unfolder bridge for switching between buck and boost modes.

2. The partial power processing (PPP) converter circuit of claim 1 wherein the converter has a auk topology.

3. The partial power processing (PPP) converter circuit of claim 2 wherein the Ćuk topology has only two high frequency switches.

4. The partial power processing (PPP) converter circuit of claim 1 wherein the unfolder bridge is turned off simultaneously with active switches Q₁ and Q₂ to switch between buck and boost modes.

5. The partial power processing (PPP) converter circuit of claim 4 wherein the active switches Q₁ and Q₂ remain active in both buck and boost modes.

6. The partial power processing (PPP) converter circuit of claim 1 wherein the unfolder comprises a bridge of four bidirectional blocking switches.

7. An unfolder circuit for switching a partial power processing (PPP) converter between buck and boost modes.

8. The unfolder circuit of claim 7 comprising a bridge of four bidirectional blocking switches.

9. The unfolder circuit of claim 8 wherein the four switches comprise active switches Q₁ and Q₂ to switch between buck and boost modes.

10. The unfolder circuit of claim 9 wherein the active switches Q₁ and Q₂ remain active in both buck and boost modes.

11. A partial power processing (PPP) converter circuit comprising:
a photovoltaic array string that generates a voltage V_{PV} and current I_{PV};
a battery that supplies a voltage V_{BATT} and current I_{BATT}; and
a PPP converter connected in a circuit between the photovoltaic array string and the battery, the converter alternately operable in buck mode and boost mode, wherein the converter is an isolated bi-directional dc-dc converter having a auk topology.

12. The partial power processing (PPP) converter circuit of claim 11 comprising an unfolder bridge for switching between buck and boost modes.

13. The partial power processing (PPP) converter circuit of claim 11 wherein the auk topology has only two high frequency switches.

14. The partial power processing (PPP) converter circuit of claim 12 wherein the unfolder bridge is turned off simultaneously with active switches Q₁ and Q₂ to switch between buck and boost modes.

15. The partial power processing (PPP) converter circuit of claim 14 wherein the active switches Q₁ and Q₂ remain active in both buck and boost modes.

16. The partial power processing (PPP) converter circuit of claim 12 wherein the unfolder comprises a bridge of four bidirectional blocking switches.

17. The partial power processing (PPP) convert circuit of claim 11 wherein the PP converter is connected in series in the circuit between the photovoltaic array string and the battery.

18. A partial power processing (PPP) converter circuit comprising:
a photovoltaic array string that generates a voltage V_{PV} and current I_{PV};
a battery that supplies a voltage V_{BATT} and current I_{BATT};
a PPP converter connected in series in a circuit between the photovoltaic array string and the battery, the converter alternately operable in buck mode and boost mode, wherein the converter is an isolated bi-directional dc-dc converter; and
a set of switches enabling an output of the dc-dc converter to be inverted when switching from the buck mode to the boost mode.

19. The partial power processing (PPP) converter circuit of claim 18 wherein the converter has a Ćuk topology.

20. The partial power processing (PPP) converter circuit of claim 19 wherein the Ćuk topology has only two switches.

21. The partial power processing (PPP) converter circuit of claim 18 comprising active switches Q₁ and Q₂ which remain active in both buck and boost modes.
